(19) United States
(12) Patent Application Publication
(10) Pub. No.: US 2015/0336813 A1
(43) Pub. Date: Nov. 26, 2015

(54) ULTRAPURE WATER PRODUCTING APPARATUS

(71) Applicant: KURITA WATER INDUSTRIES LTD., Tokyo (JP)

(72) Inventor: Nozomu IKUNO, Nakano-ku, Tokyo (JP)

(73) Assignee: KURITA WATER INDUSTRIES LTD., Nakano-ku, Tokyo (JP)

(21) Appl. No.: 14/409,891

(22) PCT Filed: Jul. 13, 2012
(86) PCT No.: PCT/JP2012/067894

§ 371 Date: Aug. 18, 2015

(51) Int. Cl. C02F 1/44; B01D 63/00; B01D 61/08

(52) U.S. Cl. CPC C02F 1/441; B01D 61/08; B01D 63/00; B01D 2311/04; B01D 2311/06; C02F 2103/346

(57) ABSTRACT

Provided is an ultrapure water producing apparatus equipped with fewer reverse osmosis membrane separation units. The ultrapure water producing apparatus includes a primary water purification system 2 and a subsystem 3 configured to treat water treated by the primary water purification system 2. A reverse osmosis membrane separation unit is provided in at least the primary water purification system 2. The reverse osmosis membrane separation unit installed in the primary water purification system 2 is a high-pressure reverse osmosis membrane separation unit installed in a single stage. The high-pressure reverse osmosis membrane separation unit has a standard operating pressure of 5.52 MPa, a pure water flux of 0.5 m³/m²·D or more, and a NaCl rejection of 99.5% or more (32,000 mg/L NaCl).

### FIELD OF INVENTION

The present invention relates to ultrapure water producing apparatuses, and particularly to an ultrapure water producing apparatus including a primary water purification system equipped with a reverse osmosis membrane separation unit (RO unit).

### BACKGROUND OF INVENTION

As shown in FIG. 2, ultrapure water for use in semiconductor cleaning is usually produced by treating raw water (e.g., industrial water, tap water, well water, and used ultrapure water discharged from semiconductor plants (hereinafter referred to as “recovered water”)) by an ultrapure water producing system including a pretreatment system 1′, a primary water purification system 2′, and a subsystem (secondary water purification system) 3′. The role of each system in FIG. 2 is as follows.

The pretreatment system 1′ includes a flocculation unit, a pressure flotation (sedimentation) unit, and a filtration (membrane filtration) unit. The system removes suspended substances and colloidal substances from raw water. During this process, other contaminants including polymeric organic matter and hydrophobic organic matter can also be removed.

The primary water purification system 2′ includes reverse osmosis membrane separation (RO) units, a degasification unit, and an ion exchange unit (e.g., mixed-bed type or four-bed, five-tower type). The system removes ions and organic components from raw water. The reverse osmosis membrane separation units remove salts and also remove ionic or colloidal TOC. The ion exchange unit removes salts and also removes TOC components by adsorption onto or ion exchange through an ion exchange resin. The degasification unit removes inorganic carbon (IC) and dissolved oxygen (DO).

The subsystem 3′ includes a low-pressure ultraviolet oxidation unit, an ion exchange water purification unit, and an ultrafiltration membrane separation unit. The subsystem further purifies the pure water produced by the primary water purification system 2′ to produce ultrapure water. The low-pressure ultraviolet oxidation unit decomposes TOC into organic acids and CO₂ with ultraviolet radiation of a wavelength of 185 nm emitted from a low-pressure ultraviolet lamp. The resulting organic matter and CO₂ are removed by an ion exchange resin in the ion exchange unit. The ultrafiltration membrane separation unit removes fine particles and also removes particles liberated from the ion exchange resin.

Although the reverse osmosis membrane separation units in FIG. 2 are disposed on the upstream and most downstream sides of the primary water purification system, they may be installed in two stages in series. Although a single pretreatment system is installed in FIG. 2, a pretreatment system for treating water such as tap water and industrial water and a dilute wastewater recovery system for treating dilute wastewater such as wastewater produced from semiconductor manufacturing processes may be installed in parallel.

### LIST OF LITERATURE

### Patent Literature

Patent Literature 1: Japanese Patent 3468784 Object and Summary of Invention

### OBJECT OF INVENTION

Conventional primary water purification or wastewater recovery systems for ultrapure water producing systems employ usually a two-stage RO configuration in which water is passed through RO separation units installed in two stages connected in series so as to reduce the organic concentration. Because raw water to be treated by the systems is industrial water, tap water, well water, or dilute wastewater with low salt load, the systems use usually ultra-low-pressure RO membranes with a standard operating pressure of 0.75 MPa and a pure water flux of 25 m³/m²·D/unit (8 inches) or more or low-pressure RO membranes with a standard operating pressure of 1.47 MPa and a pure water flux of 25 m³/m²·D/unit (8 inches) or more.

The reverse osmosis membrane separation units installed in two stages require a large space and a complicated unit operation management. A primary water purification system for ultrapure water producing plants in semiconductor manufacturing factories includes usually about 4 to 40 reverse osmosis membrane separation units installed in parallel in the first stage and a similar number of reverse osmosis membrane separation units installed in parallel in the second stage. The installation of such numerous reverse osmosis membrane separation units requires high equipment and operating costs of reverse osmosis membrane separation units and a large space.

An object of the present invention is to solve problems of the above conventional apparatuses and to provide an ultrapure water producing apparatus equipped with fewer reverse osmosis membrane separation units.

### SUMMARY OF INVENTION

An ultrapure water producing apparatus according to the present invention includes a primary water purification system and a subsystem configured to treat water treated by the primary water purification system. A reverse osmosis membrane separation unit is provided in at least the primary water purification system. The reverse osmosis membrane separation unit installed in the primary water purification system is a high-pressure reverse osmosis membrane separation unit installed in a single stage.

The high-pressure reverse osmosis membrane separation unit preferably has a standard operating pressure of 5.52 MPa or more and has a pure water flux of 0.5 m³/m²·D or more and a NaCl rejection of 99.5% or more (32,000 mg/L NaCl) at the standard operating pressure.

The apparatus according to the present invention may further include a pretreatment system configured to treat raw water. The water treated by the pretreatment system may be sequentially treated by the primary water purification system and the subsystem. The water supplied to the high-pressure reverse osmosis membrane separation unit may have a TDS (total dissolved solids) of 1,500 mg/L or less.

The effective transmembrane pressure of the high-pressure reverse osmosis membrane separation unit is preferably 1.5 to 3 MPa.

### Advantageous Effects of Invention

High-pressure reverse osmosis membrane separation units are conventionally used in seawater desalination plants. For the reverse osmosis membrane treatment of seawater, which has a high salt concentration, high-pressure reverse osmosis membrane separation units are used at a high effective transmembrane pressure (the difference in pressure between the primary and secondary sides), i.e., about 5.52 MPa.

In the present invention, high-pressure reverse osmosis membrane separation units are installed in a single stage (one stage) in the primary water purification system of the ultrapure water producing apparatus. A typical reverse osmosis membrane for seawater desalination has a high organic rejection because it includes a skin layer, which contributes to desalination and removal of organic matter, with a dense molecular structure. For seawater desalination, the raw water has a high salt concentration, which results in a high osmotic pressure. To achieve a sufficient permeate flow rate, the effective transmembrane pressure should be 5.5 MPa or more. In contrast, the raw water to be treated with common RO membranes in the electronic industry has a low salt concentration, i.e., a TDS (total dissolved solids) of 1,500 mg/L or less. Because such raw water has a low osmotic pressure, a sufficient permeate flow rate can be achieved at an effective transmembrane pressure of about 2 to 3 MPa. As described above, the permeate water has a significantly higher quality than water treated with conventional reverse osmosis membranes (ultra-low-pressure and low-pressure reverse osmosis membranes).

Thus, if high-pressure reverse osmosis membrane separation units are installed in a single stage in the primary water purification system, the number of reverse osmosis membrane separation units installed is half that of a conventional two-stage configuration. This halves the installation space of reverse osmosis membrane separation units and also substantially halves the equipment and operating/management costs.

### BRIEF DESCRIPTION OF DRAWINGS

FIG. 1 is a system diagram of an example embodiment of an ultrapure water producing apparatus according to the present invention.

FIG. 2 is a system diagram of a conventional ultrapure water producing apparatus.

### DESCRIPTION OF EMBODIMENTS

Embodiments of ultrapure water producing apparatuses of the present invention will now be described in detail.

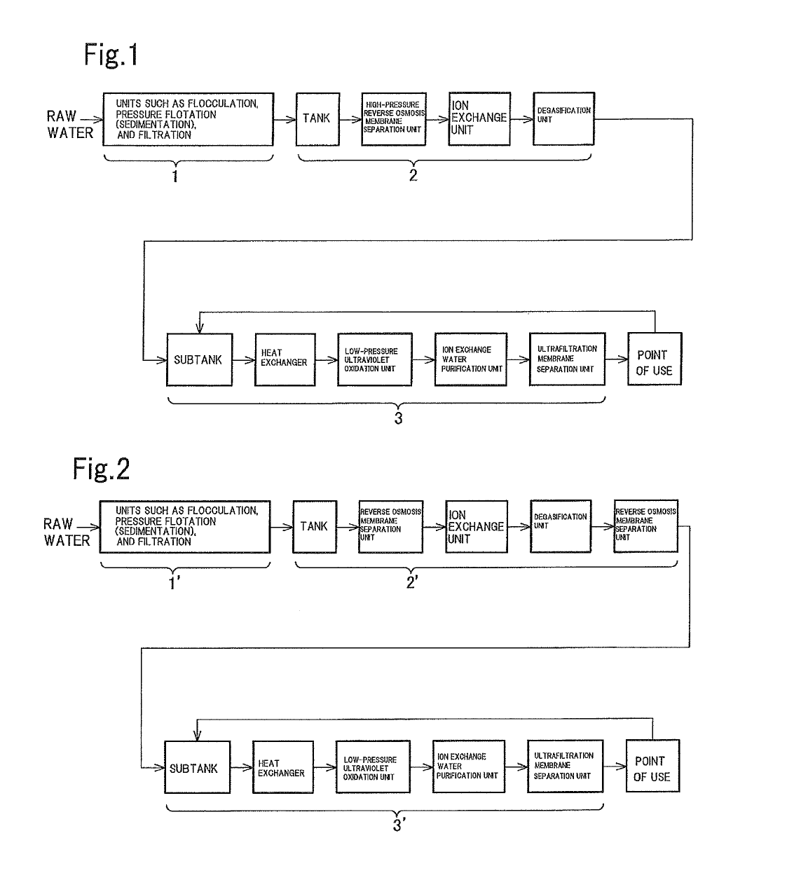

In the present invention, as shown in FIG. 1, ultrapure water is preferably produced by sequentially treating raw water through a pretreatment system 1, a primary water purification system 2, and a subsystem 3. High-pressure reverse osmosis membrane separation units serving as reverse osmosis membrane separation units (RO units) are installed in a single stage in the primary water purification system 2.

A high-pressure reverse osmosis membrane separation unit has been used in seawater desalination and has a standard operating pressure of 5.52 MPa or more and has a pure water flux of 0.5 m³/m²·D or more and a NaCl rejection of 99.5% or more (32,000 mg/L NaCl) at the standard operating pressure. The NaCl rejection is measured at 25° C. using an aqueous NaCl solution with a NaCl concentration of 32,000 mg/L. High-pressure, low-pressure, and ultra-low-pressure reverse osmosis membranes can be distinguished based on data from catalogues (including technical documents) available from membrane manufacturers that list the specifications of their reverse osmosis membranes.

A high-pressure reverse osmosis membrane includes a denser skin layer, which forms the outer surface thereof, than a low-pressure or ultra-low-pressure reverse osmosis membrane used in a primary water purification system of a conventional ultrapure water producing apparatus. Thus, a high-pressure reverse osmosis membrane has a lower membrane permeate flow rate per unit operating pressure and an extremely higher organic rejection than a low-pressure or ultra-low-pressure reverse osmosis membrane. When a reverse osmosis membrane is used to treat feed water with a salt concentration of 1,500 mg/L or less TDS (total dissolved solids), a maximum osmotic pressure applied thereto is about 1.0 MPa under an operating condition of a recovery of 90%. Accordingly, when a high-pressure reverse osmosis membrane separation unit is used to treat feed water with a TDS of 1,500 mg/L or less, the unit is preferably used at an effective transmembrane pressure (the difference in pressure between the primary and secondary sides) of about 1.5 to 3 MPa, more preferably about 2 to 3 MPa, to achieve a flow rate similar to that of a low-pressure or ultra-low-pressure reverse osmosis membrane. As a result, water can be treated only by one-stage RO membrane treatment with a quality and flow rate similar to those of conventional two-stage RO membrane treatment. This requires fewer membrane units, vessels, and pipes and therefore contributes to cost reduction and space saving.

The reverse osmosis membranes may be membranes of any shape, such as spiral wound membranes, hollow fiber membranes, 4 inch RO membranes, 8 inch RO membranes, or 16 inch RO membranes.

Although raw water is treated by the pretreatment system 1 before being supplied to the primary water purification system 2 in FIG. 1, a dilute wastewater treatment system (not shown) may be installed in parallel with the pretreatment system 1, and water treated by the dilute wastewater treatment system may be supplied to the primary water purification system. In this case, in the flow in FIG. 1, a tank is preferably installed upstream of the primary water purification system 2 such that both the treated water from the pretreatment system 1 and the treated water from the dilute wastewater treatment system flow into the tank.

### EXAMPLES

### Experiment 1

Electronic device factory wastewater (electrical conductivity: 100 mS/m, TDS: 600 mg/L, TOC: 10 mg/L) was passed through a high-pressure reverse osmosis membrane separation unit (RO membrane: SWC4+ available from Nitto Denko Corporation, flux at operating pressure of 5.52 MPa: 24.6 m³/m²·D, NaCl rejection: 99.8% (32,000 mg/L NaCl)) installed in a single stage at a recovery of 73%. As a result, the permeate water had a TOC of 0.85 mg/L. The effective transmembrane pressure was 2.0 MPa.

### Experiment 2

The same electronic device factory wastewater used in Experiment 1 was passed through RO units installed in two stages and equipped with an ultra-low-pressure RO membrane (ES-20 available from Nitto Denko Corporation) at a condition where an upstream RO recovery is 75%, a downstream RO recovery is 90%, and a total water recovery is 73% (the downstream RO concentrate water was returned to the upstream RO feed water). As a result, the first-stage RO permeate water had a TOC concentration of 1.35 mg/L, and the second-stage RO permeate water had a TOC concentration of 0.9 mg/L. The effective transmembrane pressure was 0.5 MPa in the first stage and was 0.75 MPa in the second stage.

Experiments 1 and 2 demonstrated that the quality of permeate water produced by the high-pressure reverse osmosis membrane separation unit installed in a single stage was similar to that of permeate water produced by the ultra-low-pressure reverse osmosis membrane separation units installed in two stages. In Experiment 2, the first-stage RO permeate water had a TOC concentration as high as 1.35 mg/L, demonstrating that the ultra-low-pressure reverse osmosis membrane separation unit installed in a single stage was less effective in removing TOC and TDS than the high-pressure reverse osmosis membrane separation unit.

Next, further experiment was conducted. This experiment used an ultrapure water producing apparatus same as that shown in FIG. 2 except that the primary water purification system thereof was replaced by the primary water purification system shown in FIG. 1 having the above high-pressure reverse osmosis membrane separation unit installed in a single stage. This ultrapure water producing apparatus was operated at an effective transmembrane pressure of 2.0 MPa of the high-pressure reverse osmosis membrane separation unit. By this operation, ultrapure water was produced with a quality similar to that of water produced by a conventional apparatus (having ROs in a two-stage, first-stage effective transmembrane pressure: 0.5 MPa, second-stage effective transmembrane pressure: 0.75 MPa) at substantially the same product flow rate.

Whereas particular embodiments of the present invention have been described in detail, a person skilled in the art would appreciate that various modifications can be made without departing from the spirit and scope of the present invention.

This application is based on a Japanese patent application 2011-117142 filed on May 25, 2011, the entire content of which is herein incorporated by reference.

1. An ultrapure water producing apparatus comprising a primary water purification system and a subsystem for treating water treated by the primary water purification system, at least the primary water purification system comprising a reverse osmosis membrane separation unit,
wherein the reverse osmosis membrane separation unit installed in the primary water purification system is a high-pressure reverse osmosis membrane separation unit installed in a single stage.

2. The ultrapure water producing apparatus according to claim 1, wherein the high-pressure reverse osmosis membrane separation unit has a standard operating pressure of 5.52 MPa or more and has a pure water flux of 0.5 m³/m²·D or more and a NaCl rejection of 99.5% or more (32,000 mg/L NaCl) at the standard operating pressure.

3. The ultrapure water producing apparatus according to claim 1, wherein the apparatus further comprises a pretreatment system for treating raw water whereby the water treated by the pretreatment system is sequentially treated by the primary water purification system and the subsystem, and
wherein the water supplied to the high-pressure reverse osmosis membrane separation unit has a TDS of 1,500 mg/L or less.

4. The ultrapure water producing apparatus according to claim 1, wherein the effective transmembrane pressure of the high-pressure reverse osmosis membrane separation unit is 1.5 to 3 MPa.
